(19) United States
(12) Patent Application Publication
(10) Pub. No.: US 2018/0232800 A1
(43) Pub. Date: Aug. 16, 2018

(54) Virtual Retail Showroom System

(71) Applicant: Wal-Mart Stores, Inc., Bentonville, AR (US)

(72) Inventors: Todd Davenport Mattingly, Bentonville, AR (US); David G. Tovey, Rogers, AR (US)

(21) Appl. No.: 15/877,517

(22) Filed: Jan. 23, 2018

Related U.S. Application Data
(60) Provisional application No. 62/459,696, filed on Feb. 16, 2017.

(51) Int. Cl. G06Q 30/06; G06F 3/01; G02B 27/01

(52) U.S. Cl. CPC G06Q 30/0643; G06F 3/017; H04N 13/044; G02B 27/017; G06F 3/016

(57) ABSTRACT

Described in detail herein are systems and methods for a virtual show room. A user using an optical scanner can scan a machine-readable element associated with a physical object. The computing system can receive the identifier and can build a 3D virtual simulation environment including the physical object. A virtual reality headset including inertial sensors and a display can render the 3D virtual simulation environment including the physical object on the display. The virtual reality headset can detect a user gesture using at least one of the plurality of inertial sensors. The virtual reality headset can execute an action in the 3D virtual simulation environment based on the user gesture to provide a demonstrable property or function of the physical object. The virtual reality headset can generate sensory feedback using sensory feedback devices based on a set of sensory attributes associated with the physical object.

### CROSS-REFERENCE TO RELATED PATENT APPLICATIONS

This application claims priority to U.S. Provisional Application No.: 62/459,696 filed on Feb. 16, 2017, the content of which is hereby incorporated by reference in its entirety.

### BACKGROUND

It can be difficult to simulate the operation of physical objects in various different environments while disposed in a facility.

### BRIEF DESCRIPTION OF DRAWINGS

Illustrative embodiments are shown by way of example in the accompanying drawings and should not be considered as a limitation of the present disclosure. The accompanying figures, which are incorporated in and constitute a part of this specification, illustrate one or more embodiments of the invention and, together with the description, help to explain the invention. In the figures:

FIG. 1 is a schematic diagram of an exemplary arrangement of physical objects disposed in a facility according to an exemplary embodiment;

FIG. 2A is a block diagram of a virtual reality headset configured to present a virtual third dimensional (3D) simulation environment according to an exemplary embodiment;

FIG. 2B is a schematic illustration of the virtual reality headset of FIG. 2A according to exemplary embodiments;

FIG. 2C illustrates a virtual 3D simulation environment rendered on a virtual headset in accordance with an exemplary embodiment;

FIG. 3 illustrates inertial sensors for interacting with a virtual 3D simulation environments in accordance with an exemplary embodiment;

FIG. 4 illustrates an exemplary virtual showroom system in accordance with an exemplary embodiment;

FIG. 5 illustrates a block diagram an exemplary computing device in accordance with an exemplary embodiment; and

FIG. 6 is a flowchart illustrating a process implemented by a virtual showroom system according to an exemplary embodiment.

### DETAILED DESCRIPTION

Described in detail herein are systems and methods for a virtual show room. In exemplary embodiments, a user using an optical scanner can scan a machine-readable element disposed on a label encoded with an identifier associated with a physical object. The optical scanner can transmit the identifier to a computing system, and can build a 3D virtual simulation environment including a representation of the physical object associated with the scanned media-readable element. A virtual reality headset can include inertial sensors, and a display system. The virtual reality headset can render the 3D virtual simulation environment to include the representation of the physical object on the display system. The virtual reality headset can detect a user gesture based on an output of at least one of the plurality of inertial sensors. The first user gesture can corresponds to an interaction between the user and the representation of the physical object rendered in the 3D virtual simulation environment. The virtual reality headset can execute an action in the 3D virtual simulation environment based on the user gesture to simulate a demonstrable property or function of the physical object. The virtual reality headset can generate sensory feedback using sensory feedback devices based on a set of sensory attributes associated with the physical object in response to executing the action executed in the 3D virtual simulation environment.

The computing system can be further programmed to build the 3D virtual simulation environment to include representations of additional physical objects associated with additional machine-readable elements in the facility, and the first user gesture can result in an interaction between the representation of the physical object and the representations of additional physical object in the first 3D virtual simulation environment. The virtual reality headset can be configured to extract and isolate one or more 3D images of the representations of the physical object and additional physical objects from the 3D virtual simulation environment, adjust the size of the one or more 3D images, render the one or more 3D images of the physical object on a first side of the display to have a first size and render the one or more 3D images of the additional physical objects on a second side of the display to have a second size that is smaller than the first size to accommodate the one or more 3D images on the display. The user gesture corresponds to selection of at least one of the one or more 3D images of the additional physical objects. In response to selection of at least one of the one or more 3D images associated with the additional physical objects, the virtual reality headset can enlarge the at least one or more 3D images rendered on the display.

The computing system is programmed to detect a second user gesture based on an output of at least one of the plurality of inertial sensors, the second user gesture corresponding to an interaction between the user and the first 3D virtual simulation environment, execute a second action in the 3D virtual simulation environment based on the second user gesture to provide a demonstrable property or function of the at least one of the additional physical objects and generate sensory feedback based on a second set of sensory attributes associated with the at least one of the additional physical objects in response to executing the second action in the 3D virtual simulation environment.

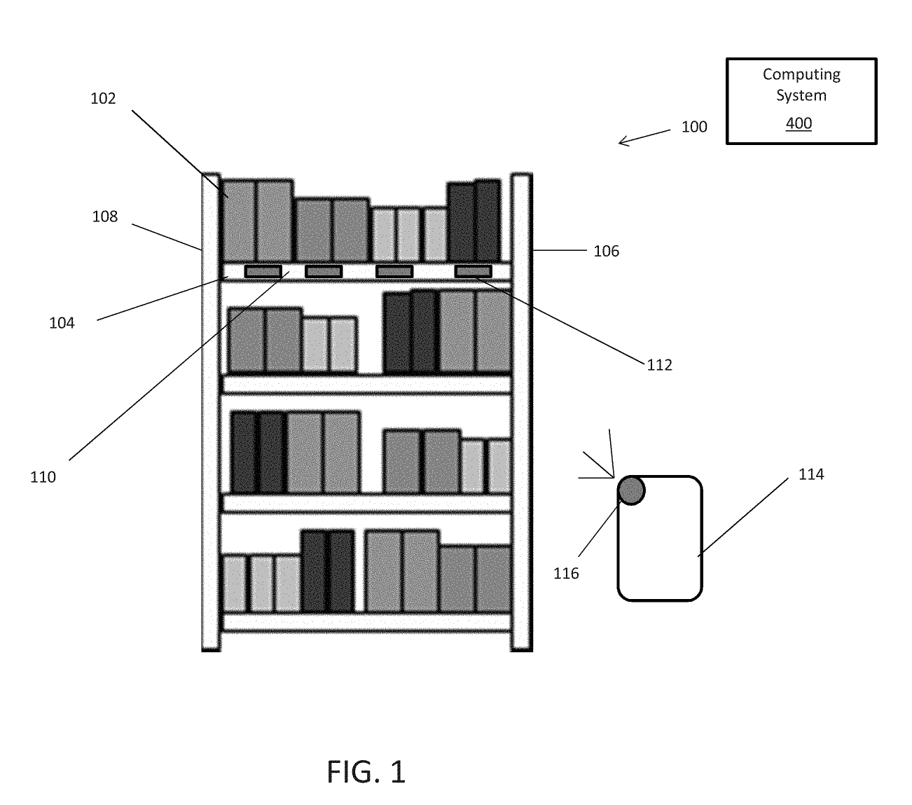

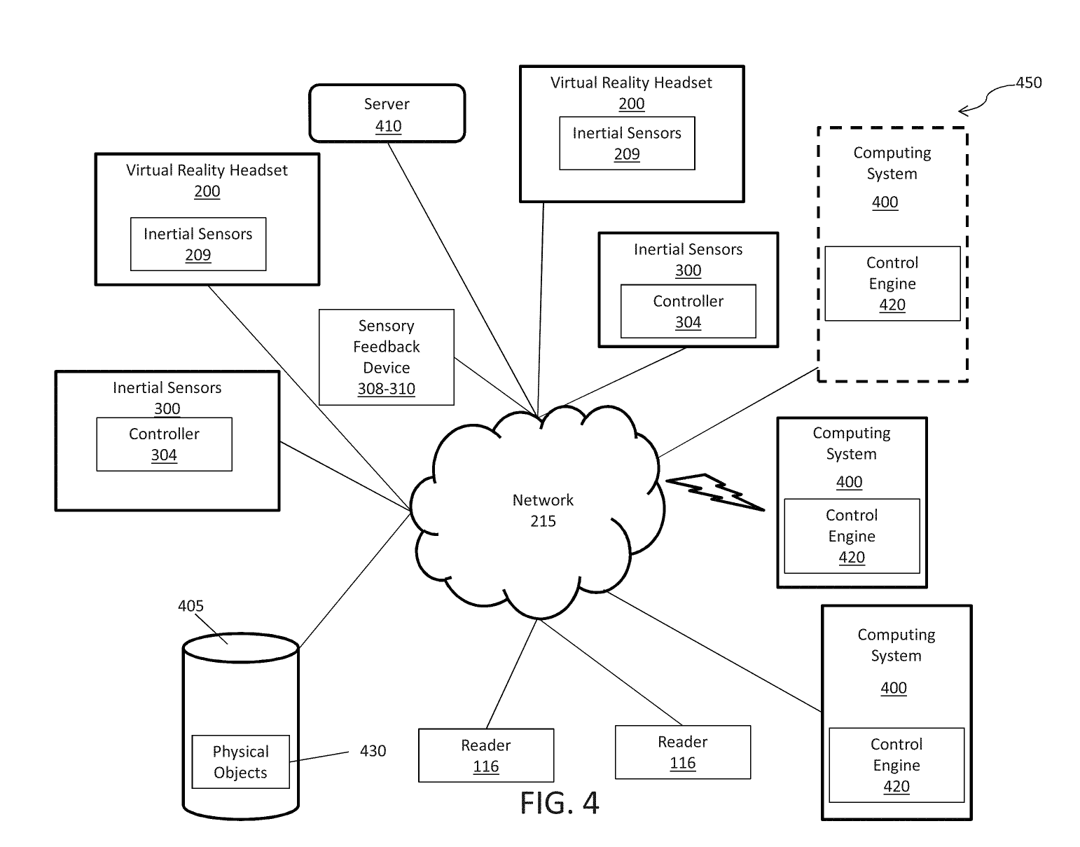

FIG. 1 is a schematic diagram of an exemplary arrangement physical objects disposed in a facility according to an exemplary embodiment. A shelving unit 100 can include several shelves 104 holding physical objects 102. The shelves 104 can include a top or supporting surface extending the length of the shelf 104. The shelves 104 can also include a front face 110. Labels 112, including machine-readable elements, can be disposed on the front face 110 of the shelves 104. The machine-readable elements can be encoded with identifiers associated with the physical objects disposed on the shelves 104. The machine-readable elements can be barcodes, QR codes, RFID tags, and/or any other suitable machine-readable elements. A device 114 (i.e. mobile device) including an reader 116 (e.g., an optical scanner or RFID reader) can be configured to read and decode the identifiers from the machine-readable elements. The device 114 can communicate the decoded identifiers to a computing system. An example computing system is described in further detail with reference to FIG. 4.

In some embodiments, images of the physical objects and machine-readable elements disposed with respect to the images can be presented to a user (e.g., such that the actual physical object is not readily observable by the user. The user can scan the machine-readable elements using the device 114 including the reader 116. In another embodiment, the images of physical objects can be presented via a virtual reality headset and a user can select an image of a physical objects by interacting with the virtual reality headset as will be described herein.

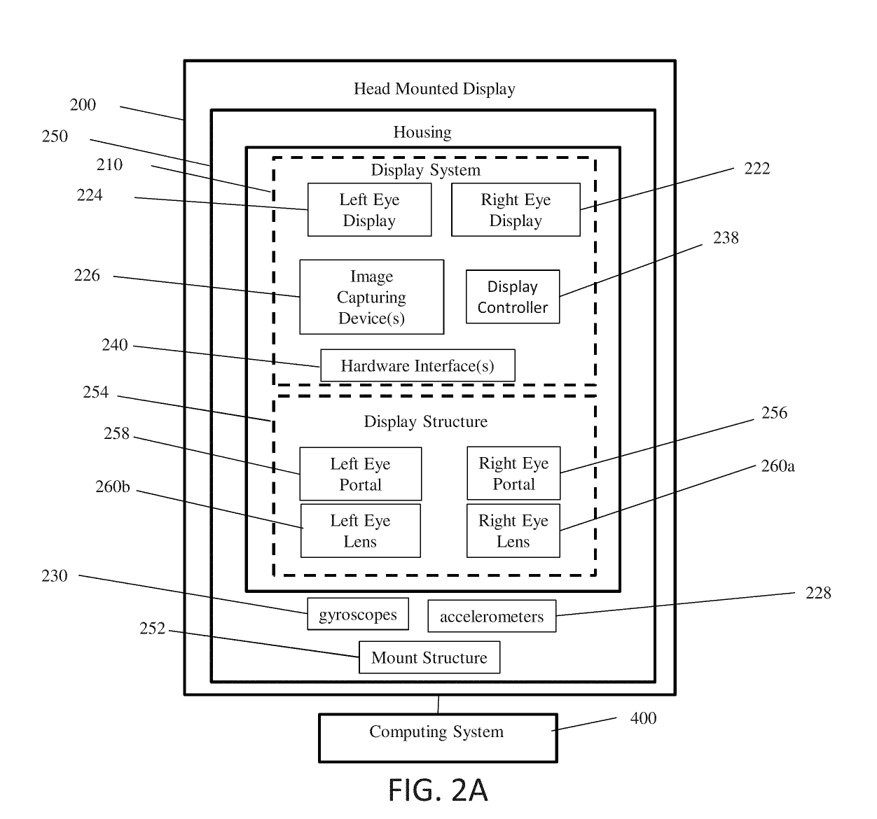

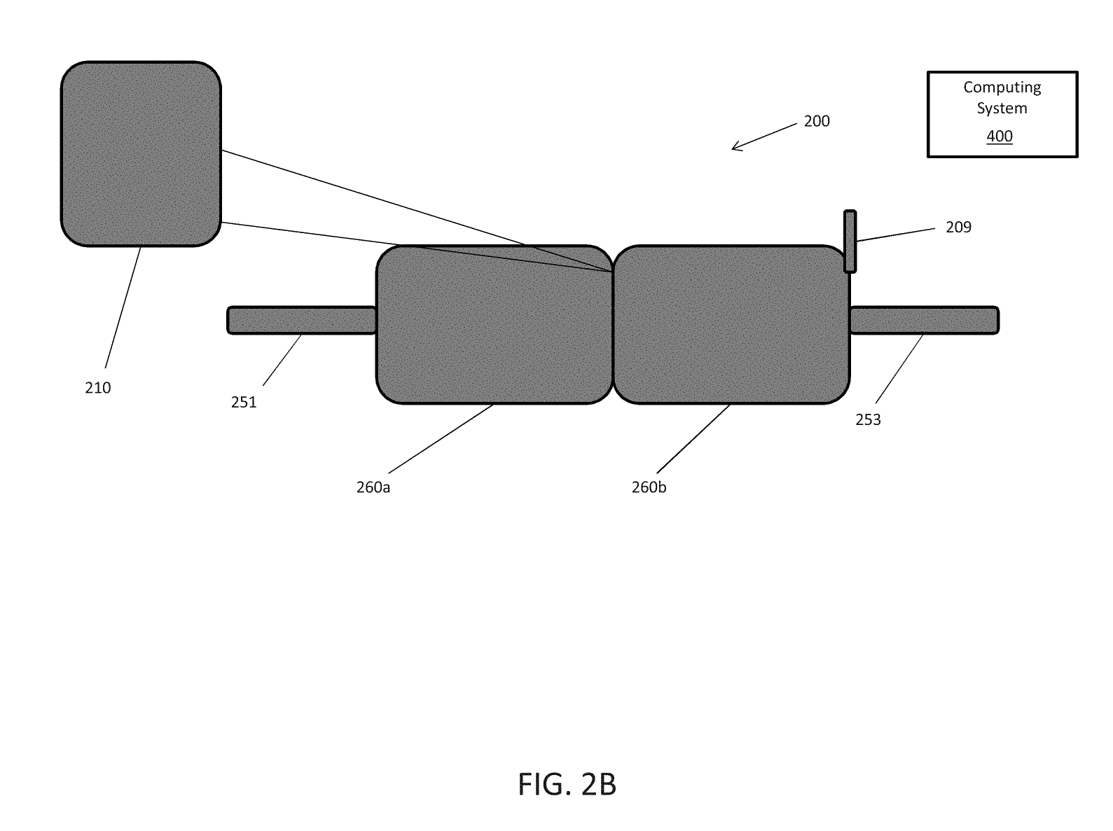

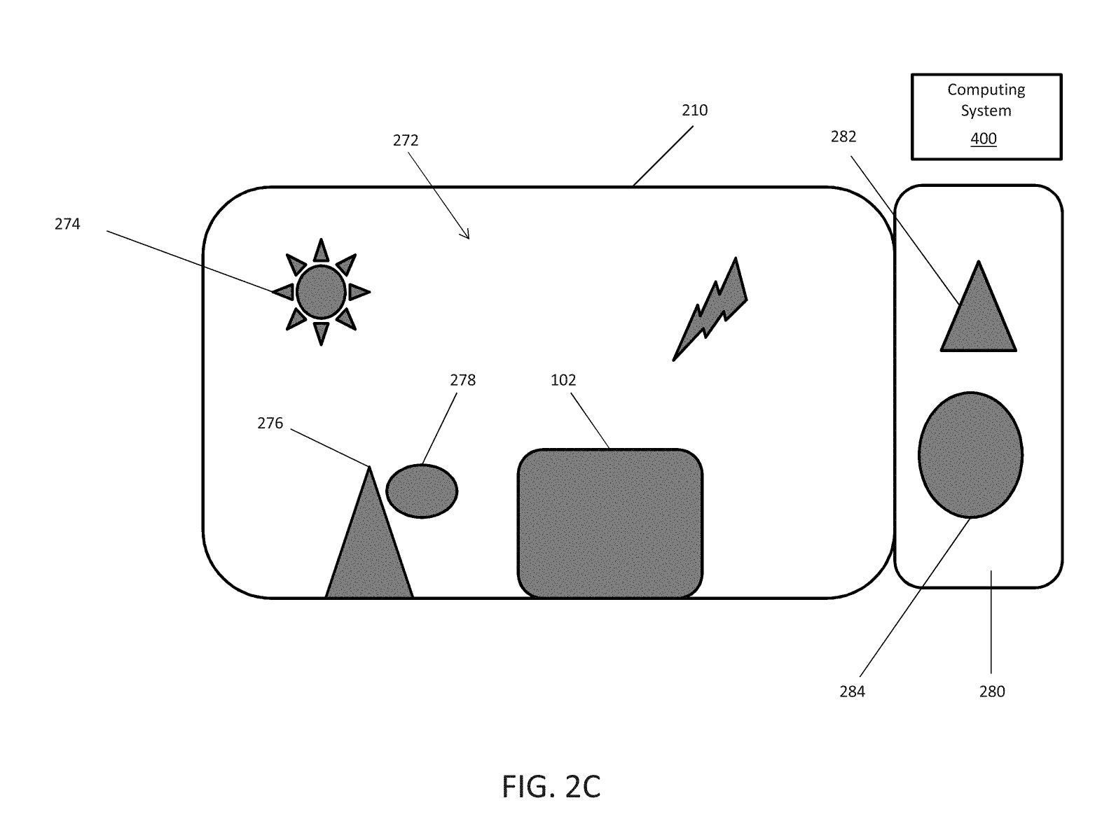

FIG. 2A-B illustrates a virtual reality headset 200 for presenting a virtual 3D simulation environment according to an exemplary embodiment. The virtual reality headset 200 can be a head mounted display (HMD). The virtual reality headset 200 and the computing system 400 can be communicatively coupled to each other via wireless or wired communications such that the virtual reality headset 200 and the computing system 400 can interact with each other to implement the 3D virtual simulation environment. The computing system 400 will be discussed in further details with reference to FIG. 4.

The virtual reality headset 200 include circuitry disposed within a housing 250. The circuitry can include a display system 210 having a right eye display 222, a left eye display 224, one or more image capturing devices 226, one or more display controllers 238 and one or more hardware interfaces 240. The display system 210 can display a 3D virtual simulation environment.

The right and left eye displays 222 and 224 can be disposed within the housing 250 such that the right display is positioned in front of the right eye of the user when the housing 250 is mounted on the user's head and the left eye display 224 is positioned in front of the left eye of the user when the housing 250 is mounted on the user's head. In this configuration, the right eye display 222 and the left eye display 224 can be controlled by one or more display controllers 238 to render images on the right and left eye displays 222 and 224 to induce a stereoscopic effect, which can be used to generate three-dimensional images. In exemplary embodiments, the right eye display 222 and/or the left eye display 224 can be implemented as a light emitting diode display, an organic light emitting diode (OLED) display (e.g., passive-matrix (PMOLED) display, active-matrix (AMOLED) display), and/or any suitable display.

In some embodiments the display system 210 can include a single display device to be viewed by both the right and left eyes. In some embodiments, pixels of the single display device can be segment by the one or more display controllers 238 to form a right eye display segment and a left eye display segment within the single display device, where different images of the same scene can be displayed in the right and left eye display segments. In this configuration, the right eye display segment and the left eye display segment can be controlled by the one or more display controllers 238 disposed in a display to render images on the right and left eye display segments to induce a stereoscopic effect, which can be used to generate three-dimensional images.

The one or more display controllers 238 can be operatively coupled to right and left eye displays 222 and 224 (or the right and left eye display segments) to control an operation of the right and left eye displays 222 and 224 (or the right and left eye display segments) in response to input received from the computing system 400 and in response to feedback from one or more sensors as described herein. In exemplary embodiments, the one or more display controllers 238 can be configured to render images on the right and left eye displays (or the right and left eye display segments) of the same scene and/or objects, where images of the scene and/or objects are render at slightly different angles or points-of-view to facilitate the stereoscopic effect. In exemplary embodiments, the one or more display controllers 238 can include graphical processing units.

The headset 200 can include one or more sensors for providing feedback used to control the 3D environment. For example, the headset can include image capturing devices 226, accelerometers 228, gyroscopes 230 in the housing 250 that can be used to detect movement of a user's head or eyes. The detected movement can be used to form a sensor feedback to affect 3D virtual simulation environment. As an example, if the images captured by the camera indicate that the user is looking to the left, the one or more display controllers 238 can cause a pan to the left in the 3D virtual simulation environment. As another example, if the output of the accelerometers 228 and/or gyroscopes 230 indicate that the user has tilted his/her head up to look up, the one or more display controllers can cause a pan upwards in the 3D virtual simulation environment.

The one or more hardware interfaces 240 can facilitate communication between the virtual reality headset 200 and the computing system 400. The virtual reality headset 200 can be configured to transmit data to the computing system 400 and to receive data from the computing system 400 via the one or more hardware interfaces 240. As one example, the one or more hardware interfaces 240 can be configured to receive data from the computing system 400 corresponding to images and can be configured to transmit the data to the one or more display controllers 238, which can render the images on the right and left eye displays 222 and 224 to provide a 3D simulation environment in three-dimensions (e.g., as a result of the stereoscopic effect) that is designed to facilitate vision therapy for binocular dysfunctions Likewise, the one or more hardware interfaces 240 can receive data from the image capturing devices corresponding to eye movement of the right and left eyes of the user and/or can receive data from the accelerometer 228 and/or the gyroscope 230 corresponding to movement of a user's head. and the one or more hardware interfaces 240 can transmit the data to the computing system 400, which can use the data to control an operation of the 3D virtual simulation environment.

The housing 250 can include a mounting structure 252 and a display structure 254. The mounting structure 252 allows a user to wear the virtual reality headset 200 on his/her head and to position the display structure over his/her eyes to facilitate viewing of the right and left eye displays 222 and 224 (or the right and left eye display segments) by the right and left eyes of the user, respectively. The mounting structure can be configured to generally mount the virtual reality headset 200 on a user's head in a secure and stable manner. As such, the virtual reality headset 200 generally remains fixed with respect to the user's head such that when the user moves his/her head left, right, up, and down, the virtual reality headset 200 generally moves with the user's head.

The display structure 254 can be contoured to fit snug against a user's face to cover the user's eyes and to generally prevent light from the environment surrounding the user from reaching the user's eyes. The display structure 254 can include a right eye portal 256 and a left eye portal 258 formed therein. A right eye lens 260a can be disposed over the right eye portal and a left eye lens 260b can be disposed over the left eye portal. The right eye display 222, the one or more capturing devices 226 behind the lens 260a of the display structure 254 covering the right eye portal 256 such that the lens 256 is disposed between the user's right eye and each of the right eye display 222 and the one or more right eye image capturing devices 226. The left eye display 224 and the one or more image capturing devices 228 can be disposed behind the lens 260b of the display structure covering the left eye portal 258 such that the lens 260b is disposed between the user's left eye and each of the left eye display 224 and the one or more left eye image capturing devices 228.

The mounting structure 252 can include a left band 251 and right band 253. The left and right band 251, 253 can be wrapped around a user's head so that the right and left lens are disposed over the right and left eyes of the user, respectively. The virtual reality headset 200 can include one or more inertial sensors 209 (e.g., the accelerometers 228 and gyroscopes 230). The inertial sensors 209 can detect movement of the virtual reality headset 200 when the user moves his/her head. The virtual reality headset 200 can adjust the 3D virtual simulation environment based on the detected movement output by the one or more inertial sensors 209. The accelerometers 228 and gyroscope 230 can detect attributes such as the direction, orientation, position, acceleration, velocity, tilt, pitch, yaw, and roll of the virtual reality headset 200. The virtual reality headset 200 can adjust the 3D virtual simulation environment based on the detected attributes. For example, if the head of the user turns to the right the virtual reality headset 200 can render the 3D simulation environment to pan to the right.

FIG. 2C is a block diagram of a virtual reality headset presenting a virtual 3D simulation environment 272 according to an exemplary embodiment. The 3D virtual simulation environment 272 can include a representation of the physical object 102 associated with the machine-readable element scanned by the reader as described in FIG. 1. The 3D virtual simulation environment 272 can also include representations of physical objects 276, 278 associated with the physical object 102. The 3D virtual simulation environment 212 can include various environmental factors 274 such as weather simulations, nature simulations, interior simulations, or any other suitable environment factors. For example, in the event the physical objects 102, 276, and 278 represented in the 3D virtual simulation environment 272 are tools to be used outside, the 3D virtual simulation environment can simulate various types of weather conditions such as heat, rain or snow. The representations of the physical objects 102, 276 and 278 can be responsive to the environmental conditions by simulating changing physical properties or function of the representations of the physical objects 102, 276, and 276, such as a size, a shape, dimensions, moisture, a temperature, a weight and/or a color.

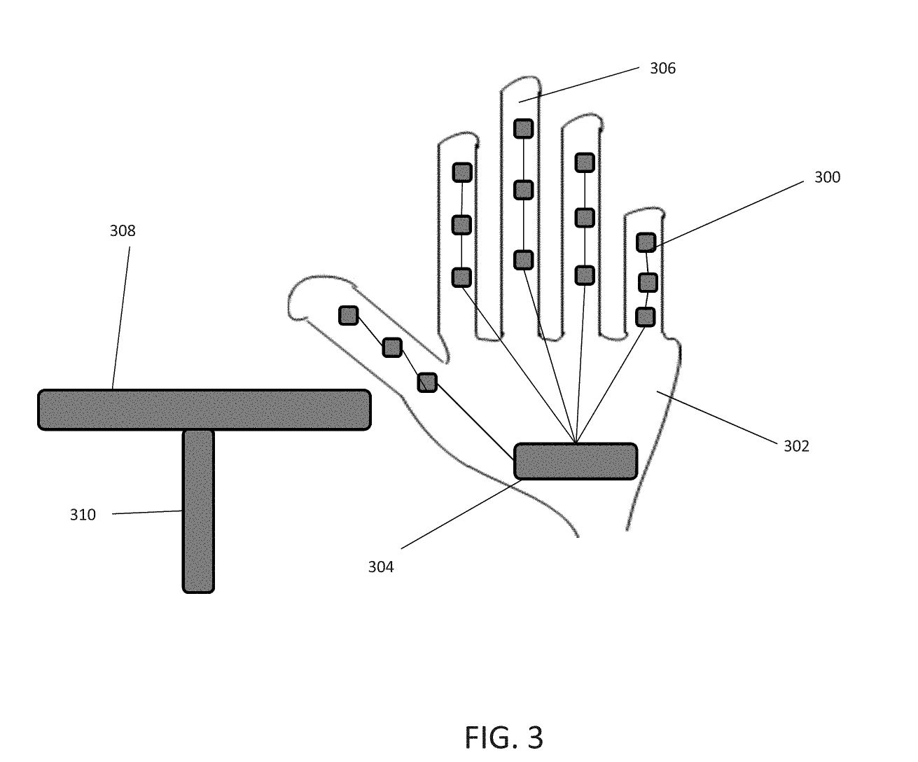

A user can interact with the 3D virtual simulation environment 272. For example, the user can view the physical objects 102, 276, 278 at different angles by moving their head and in turn moving the virtual reality headset. The output of the inertial sensors as described in FIG. 2A-B can cause the virtual reality headset to move the view of the 3D virtual simulation environment 272 so the user can view the physical objects 102, 276, 278, at different angles and perspectives based on the detected movement. The user can also interact with the 3D virtual simulation environment 272 using sensors disposed on their hands (e.g., in gloves) as described herein with respect to FIG. 3.

In some embodiments, a side panel 280 can be rendered in the 3D virtual simulation environment 272. The side panel 280 can display additional physical objects 282 and 284. A user can select representations of one or more of the physical objects 282 or 284 to be included into or excluded from the 3D virtual simulation environment 272. When two or more physical objects are being represented in the 3D virtual simulation environment 272, the 3D simulation environment can simulate an interaction between the representations of the two or more physical objects (e.g., to simulate how the two or more physical objects function together and/or apart, to simulate how the two or more physical objects look together, to simulate differences in the function or properties of the two or more physical objects).

FIG. 3 illustrates inertial sensors 300 in accordance with an exemplary embodiment. The inertial sensors 300 can be disposed on a user's hand 302 (e.g., in a glove or other wearable device). The inertial sensors 300 can be disposed throughout the digits 306 of the user's hand 302 to sense the movement of each digit separately. The inertial sensors 300 can be coupled to a controller 304. The inertial sensors 300 can detect motion of the user's hand 302 and digits 306 and can output the detected motion to the controller 304, which can communicate the motion of the user's hand 302 and digits 306 to the virtual reality headset and/or the computing system. The virtual reality headset can be configured to adjust the 3D virtual simulation environment rendered by the display system in response to the detected movement of the user's hand 302 and digits 306. For example, the user can interact with the representations of the physical objects within the 3D virtual simulation based on the motion of their hands 302 and digits 306. For example, a user can pick up, operate, throw, squeeze or perform other actions with their hands and the physical objects. It can be appreciated the inertial sensors 300 can be placed on other body parts such as feed and/or arms to interact with the physical objects within 3D virtual simulation environment.

The user can also receive sensory feedback associated with interacting with the physical objects in the 3D virtual simulation environment. The user can receive sensory feedback using sensory feedback devices such as the bars 308 and 310. The user can grab the bars 308 and/or 310 and the virtual reality headset can communicate the sensory feedback through the bars 308, 310. The sensory feedback can include attributes associated with the physical object in a stationary condition and also the physical objects responsiveness to the environment created in the 3D virtual simulation environment and/or an operation of the physical object in varying conditions. The sensory feedback can include one or more of: weight, temperature, shape, texture, moisture, smell, force, resistance, mass, density and size. In some embodiments, the inertial sensors 300 can be also embodied as the sensory feedback devices.

FIG. 4 illustrates an exemplary virtual showroom system in accordance with an exemplary embodiment. The virtual showroom system 450 can include one or more databases 405, one or more servers 410, one or more computing systems 400, one or more virtual reality headsets 200, one or more inertial sensors 300, one or more sensory feedback devices 308-310 and one or more readers 116. The virtual reality headsets 200 can include inertial sensors 209. The inertial sensors 300 can be in communication with a controller 304 that can be configured to communicate with the virtual reality headsets 200. In exemplary embodiments, the computing system 400 is in communication with one or more of the databases 405, the server 410, the virtual reality headsets 200, the inertial sensors 300 (e.g., via the controller 304), the sensory feedback devices 308-310 and the readers 116 via a communications network 415. The computing system 400 can execute one or more instances of a control engine 420. The control engine 420 can be an executable application residing on the computing system 400 to implement the virtual show room system 450 as described herein.

In an example embodiment, one or more portions of the communications network 415 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 400 includes one or more computers or processors configured to communicate with the databases 405, the server 410, the virtual reality headsets 200, the inertial sensors 300 (e.g., via the controller 304), the sensory feedback devices 308-310 and the optical scanners 116 via the network 215. The computing system 400 hosts one or more applications configured to interact with one or more components of the virtual showroom system 450. The databases 405 may store information/data, as described herein. For example, the databases 405 can include a physical objects database 430 can store information associated with physical objects. The databases 405 and server 410 can be located at one or more geographically distributed locations from each other or from the computing system 400. Alternatively, the databases 405 can be included within server 410 or computing system 400.

In one embodiment, the reader 116 can read a machine-readable element associated with a physical object. The machine-readable element can include an identifier associated with the physical object. The reader 116 can decode the identifier from the machine-readable element, and can transmit the identifier to the computing system 400. The computing system 400 can execute the control engine 420 in response to receiving the identifiers. The control engine 420 can query the physical objects database 430 using the received identifier to retrieve information associated with the physical object. The information can include, an image, size, color dimensions, weight, mass, density, texture, operation requirements, ideal operating conditions, responsiveness to environmental conditions, physical and functional simulation models for the physical object, visual representations of the physical object. The control engine 420 can also retrieve information associated with additional physical objects associated with the physical object. The control engine 420 can build a 3D virtual simulation environment incorporate a representation of the physical object and representations of additional physical objects. The 3D virtual simulation environment can include a 3D rendering of the representation of the physical object in an ideal operational environment in which the user can simulate the use of the physical object via the physical or functional simulations models. The 3D virtual simulation environment can also include a 3D rendering of the additional physical objects associated with the physical object. The control engine 220 can build the 3D rendering of the physical object and the additional physical object based on the retrieved information.

The control engine 220 can instruct the virtual reality headset to display the 3D virtual simulation environment including the representations of the physical object and the additional physical objects together. Alternatively, the control engine 220 can instruct the virtual reality headset 200 to display the 3D virtual simulation environment including the representation of the physical object and display the representations of all or some of the additional physical objects on the side panel (as discussed with reference to FIG. 2B). The size of the images of the additional physical objects can be reduced when displayed on the side panel. The virtual reality headset 200 can detect motion of a user's head via, the inertial sensors 209 and/or detect motion of a user's hands or other body parts via the inertial sensors 300, to interact with the 3D virtual simulation environment. The virtual reality headset 200 can adjust the view on the display of the 3D virtual simulation environment based on the motion of the head based on the movement detected by the inertial sensor 209. The virtual reality headset 200 can simulate interaction with the physical object and additional physical objects based on movement of detected by the inertial sensors 300 disposed on one or more body parts of a user. The user can also scroll, zoom in, zoom out, change views and or move the 3D virtual simulation environment based on movement of the inertial sensors 300. The inertial sensors 300 can communicate with the virtual headset 200, via the controller 304.

The virtual reality headset can also provide sensory feedback based on interaction with the 3D simulation environment, via the sensory feedback devices 308-310. The virtual reality headset 200 can instruct the sensory feedback devices 308-310 to output sensory feedback based on the user's interaction with the 3D simulation environment. The sensory feedback can include one or more of: weight, temperature, shape, texture, moisture, force, resistance, mass, density, size, sound, taste and smell. The sensory feedback can be affected by the environmental conditions and/or operation of the physical object in the 3D simulation environment. For example, a metal physical object can be simulated be get hot under the sun. The sensory feedback devices 308-310 can output an amount of heat corresponding to the metal of the physical object. In some embodiments, the user can select for different environmental conditions, such as weather, indoor or outdoor conditions. The control engine 420 can reconstruct the 3D simulation environment based on the user's selection and instruct the virtual reality headset 200 to display the reconstructed 3D virtual simulation environment.

In some embodiments, the user may be in a room including sensory feedback devices 308-310. The sensory feedback devices 308-310 can control the temperature, output smells corresponding to the interaction with the physical objects. The sensory feedback devices 308-310 can also output other types of environmental conditions such as wind, rain, heat, cold, snow and ice. In another embodiment the sensory feedback devices 308-310 can be disposed on a kiosk. The sensory feedback devices 308-310 can output sensory feedback via devices disposed on the kiosk.

The user can select the representations of the additional physical objects displayed on the side panel to be included in the 3D virtual simulation environment. In response to being selected, the size of the representation of the additional physical object can be enlarged and the representation of the additional physical object can be included in the 3D virtual simulation environment and can be simulated to interact with the representation of the physical object or to be compared to the representation of the physical object.

As a non-limiting example, the virtual showroom system 250 can be implemented in a retail store. The virtual showroom system 250 can include a kiosk or room that can be used by customers to simulate the use of products disposed in the retail store. The customers can compare and contrast the products using the virtual showroom system 250. A reader 116 can read a machine-readable element associated with a product disposed in the retail store or otherwise available. The machine-readable element can include an identifier associated with the product. The reader 116 can decode the identifier from the machine-readable element. The reader 116 can transmit the identifier to the computing system 400, and the computing system 400 can execute the control engine 420 in response to receiving the identifier. The control engine 420 can query the physical objects database 430 using the received identifier to retrieve information associated with the product. The information can include, an image, size, color dimensions, weight, mass, density, texture, operation requirements, ideal operating conditions, responsiveness to environmental conditions and brand, physical and functional simulation models for the physical object, and visual representations of the physical object. The control engine 420 can also retrieve information associated with additional product associated with the product. For example, the product can be a lawnmower, the control engine 420 can retrieve information associated with lawnmowers of various brands. In another example, the product can be a table setting. The customer can set a table using various china, glasses and centerpieces. The customer can view the aesthetics of each of the products in isolation and/or in combination and can change out different products to change the table setting. Furthermore, the control engine 420 can retrieve information associated with affinity products (e.g., related products, commonly paired products, etc.) associated with lawnmower such as a hedge trimmer. The control engine 420 can build a 3D virtual simulation environment. The 3D virtual simulation environment can include a 3D rendering of the product in an ideal operational environment in which the user can simulate the use of the product. The 3D virtual simulation environment can also include a 3D rendering of the additional product associated with the product. For example in continuing with our example of the lawnmower, the 3D virtual simulation environment can include a representation of the selected lawnmower, representations of lawnmowers of different brands and a representations of a hedge trimmer disposed in outdoors in a lawn with grass The control engine 220 can build the 3D rendering of the representation of the product and the representations of the additional product based on the retrieved information.

The control engine 220 can instruct the virtual reality headset to display the 3D virtual simulation environment including the representation of the product and the representation of the additional product. Alternatively, the control engine 220 can instruct the virtual reality headset 200 to display the 3D virtual simulation environment including the representation of the product and display representations of all or some of the additional products on the side panel (as discussed with reference to FIG. 2B). The size of the images of the additional products can be reduced when displayed on the side panel. The virtual reality headset 200 can detect motion of a user's head via the inertial sensors 209 and/or can detect motion of a user's hands or other body parts via the inertial sensors 300, the outputs of which can facilitate user interaction with the 3D virtual simulation environment. The virtual reality headset 200 can adjust the point-of-view on the display of the 3D virtual simulation environment based on the motion of the head detected by the inertial sensors 209. The virtual reality headset 200 can simulate interaction with the product and additional products based on movement detected by the inertial sensors 300 disposed on one or more body parts of a user. For example, a user can simulate operating the lawnmower in the 3D virtual simulation environment. The representation of the lawnmower can move and operate according to the motion detected by inertial sensors 300. The user can also scroll, zoom in, zoom out, change views and or move within the 3D virtual simulation environment based on movement of the inertial sensors 300. The inertial sensors 300 can communicate with the virtual headset 200, via the controller 304.

The virtual reality headset can also provide sensory feedback based on interaction with the 3D simulation environment, via the sensory feedback devices 308-310. The virtual reality headset 200 can instruct the sensory feedback devices 308-310 to output sensory feedback based on the user's interaction with the 3D simulation environment. The sensory feedback can include one or more of: weight, temperature, shape, texture, moisture, force, resistance, mass, density, size, sound, taste and smell. The sensory feedback can be affected by the environmental conditions and/or operation of the product in the 3D simulation environment. The sensory feedback can also simulate a resistance of pushing the lawnmower and sensory feedback related to pushing the lawnmower uphill or downhill. In some embodiments, the user can select for different environmental conditions, such as weather, indoor or outdoor conditions. The control engine 220 can reconstruct the 3D simulation environment based on the user's selection and instruct the virtual reality headset 200 to display the reconstructed 3D virtual simulation environment. The user can compare and contrast the lawnmowers of different brands and/or the affinity products.

The user can select the representations of the additional physical objects displayed on the side panel to be included in the 3D virtual simulation environment. In response to being selected, the size of the additional physical object can be enlarged and the additional physical object can be included in the 3D virtual simulation environment. The user can also pay for and checkout using the virtual reality headset 200. The user can interact with a payment/checkout screen displayed by the virtual reality headset 200. The virtual reality headset 200 can communicate with the control engine 420 so that the user can pay product displayed on in the 3D virtual simulation environment.

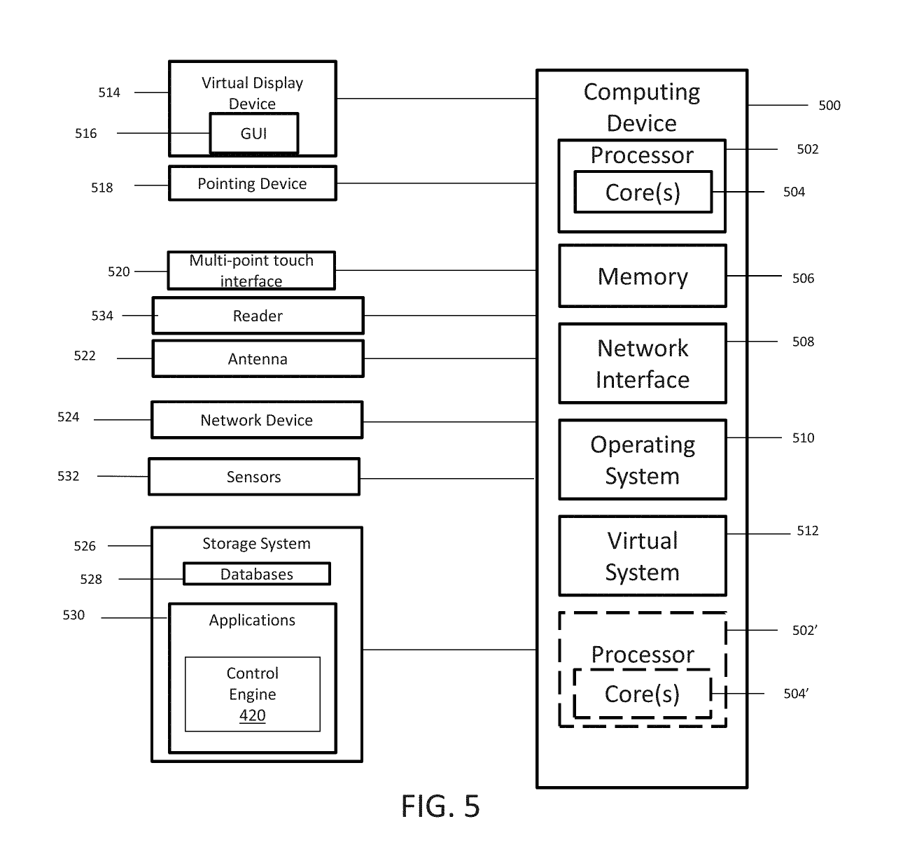

FIG. 5 is a block diagram of an exemplary computing device suitable for implementing embodiments of the automated shelf sensing system. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing device 500 may store computer-readable and computer-executable instructions or software (e.g., applications 530 such as the control engine 220) for implementing exemplary operations of the computing device 500. The computing device 300 also includes configurable and/or programmable processor 502 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for implementing exemplary embodiments of the present disclosure. Processor 502 and processor(s) 502′ may each be a single core processor or multiple core (504 and 504′) processor. Either or both of processor 502 and processor(s) 502′ may be configured to execute one or more of the instructions described in connection with computing device 500.

Virtualization may be employed in the computing device 500 so that infrastructure and resources in the computing device 500 may be shared dynamically. A virtual machine 512 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof. The computing device 500 can receive data from input/output devices such as, a reader 534 and sensors 532.

A user may interact with the computing device 500 through a visual display device 514, such as a computer monitor, which may display one or more graphical user interfaces 516, multi touch interface 520 and a pointing device 518.

The computing device 500 may also include one or more storage devices 526, such as a hard-drive, CD-ROM, or other computer readable media, for storing data and computer-readable instructions and/or software that implement exemplary embodiments of the present disclosure (e.g., applications such as the control engine 220). For example, exemplary storage device 326 can include one or more databases 528 for storing information regarding the physical objects. The databases 528 may be updated manually or automatically at any suitable time to add, delete, and/or update one or more data items in the databases. The databases 528 can include information associated with physical objects disposed in the facility and the locations of the physical objects.

The computing device 500 can include a network interface 508 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing system can include one or more antennas 522 to facilitate wireless communication (e.g., via the network interface) between the computing device 500 and a network and/or between the computing device 500 and other computing devices. The network interface 508 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

The computing device 500 may run any operating system 510, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 500 and performing the operations described herein. In exemplary embodiments, the operating system 510 may be run in native mode or emulated mode. In an exemplary embodiment, the operating system 510 may be run on one or more cloud machine instances.

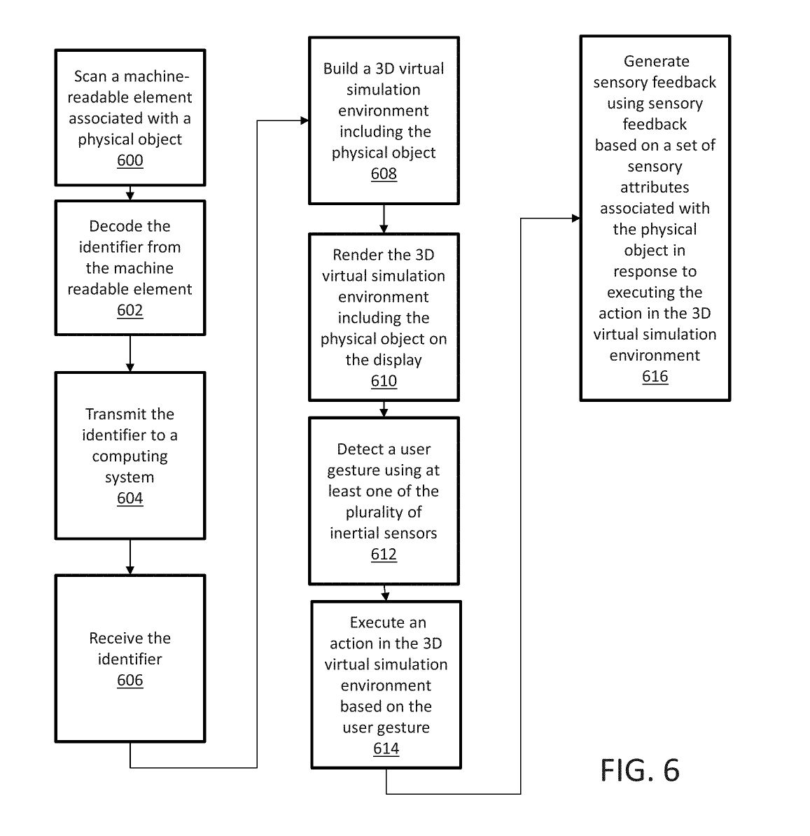

FIG. 6 is a flowchart illustrating a process of the virtual showroom system according to an exemplary embodiment. In operation 600, a reader (e.g. reader 116 as shown in FIGS. 1 and 4) can reader a machine-readable element disposed on a label (e.g. label 112 as shown in FIG. 1) encoded with a identifier associated with a physical object (e.g. physical object 102 as shown in FIG. 1). In operation 602, the reader can decode the identifier from the machine readable element. In operation 604, the reader can transmit the identifier to a computing system (e.g. computing system 400 as shown in FIG. 4). In operation 606, the computing system can receive the identifier. In operation 608, the computing system can build a 3D virtual simulation environment (e.g. 3D virtual simulation environment 272 as shown in FIG. 2C) including the physical object. In operation 610, a virtual reality headset (e.g. virtual reality headset 200 as shown in FIG. 2A-B and 4) including inertial sensors (e.g. inertial sensors 209 and 300 as shown in FIG. 2A, 3, and 4) and a display (e.g. display system 210 as shown in FIG. 2A-2C) can render the 3D virtual simulation environment including a representation of the physical object on the display. In operation 612, the virtual reality headset can detect a user gesture using at least one of the plurality of inertial sensors. The first user gesture corresponds to an interaction between the user and the 3D virtual simulation environment. In operation 614, the virtual reality headset can execute an action in the 3D virtual simulation environment based on the user gesture to provide a demonstrable property or function of the physical object. In operation 616, the virtual reality headset can generate sensory feedback using sensory feedback devices (e.g. sensory feedback devices 308-310 as shown in FIG. 3-4) based on a set of sensory attributes associated with the physical object in response to executing the action in the 3D virtual simulation environment.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A virtual retail showroom system, the system comprising:
an optical scanner, configured to scan a machine-readable element encoded with an identifier associated with a physical object, decode the identifier from the machine readable element and transmit the identifier, the machine-readable element being disposed in the facility, the physical object being at least one of available in the facility or available for delivery;
a computing system, the computing system programmed to:
receive the identifier associated with the at least one physical object;
build a first three dimensional (3D) virtual simulation environment including the first physical object based on the identifier; and
a virtual reality headset including a plurality of inertial sensors and a display, the virtual reality headset being coupled to the computing system and configured to:
render the first 3D virtual simulation environment including the first physical object on the display;
detect a first user gesture using at least one of the plurality of inertial sensors, the first user gesture corresponding to an interaction between the user and the first 3D virtual simulation environment;
execute a first action in the 3D virtual simulation environment based on the first user gesture to provide a demonstrable property or function of the first physical object; and
generate sensory feedback based on a first set of sensory attributes associated with the first physical object in response to executing the first action in the 3D virtual simulation environment.

2. The system of claim 1, wherein the computing system is further programmed to build the 3D virtual simulation environment to include additional physical objects associated with additional machine-readable elements in the facility, and the first user gesture results in an interaction between the physical object and the additional physical object in the first 3D virtual simulation environment.

3. The system of claim 2, wherein the virtual reality headset is configured to:
extract and isolate one or more 3D images of the physical object and additional physical objects from the 3D virtual simulation environment;
adjust the size of the one or more 3D images; and
render the one or more 3D images of the physical object on a first side of the display to have a first size;
render the one or more 3D images of the additional physical objects on a second side of the display to have a second size that is smaller than the first size to accommodate the one or more 3D images on the display.

4. The system of claim 3, wherein the user gesture corresponds to selection of at least one of the one or more 3D images of the additional physical objects.

5. The system of claim 4, wherein, in response to selection of at least one of the one or more 3D images associated with the additional physical objects, the virtual reality headset enlarges the at least one or more 3D images rendered on the display.

6. The system of claim 1, wherein the computing system is programmed to: add additional physical objects associated with the first physical objects to the first 3D simulation environment.

7. The system of claim 6, wherein the virtual reality headset is further configured to:
render the first 3D virtual simulation environment including the first physical object and additional physical objects associated with the first physical object on the display;
detect a second user gesture using at least one of the plurality of inertial sensors, the second user gesture corresponding to an interaction between the user and the first 3D virtual simulation environment;
execute a second action in the 3D virtual simulation environment based on the second user gesture to provide a demonstrable property or function of the at least one of the additional physical objects; and
generate sensory feedback based on a second set of sensory attributes associated with the at least one of the additional physical objects in response to executing the second action in the 3D virtual simulation environment.

8. The system of claim 1, further comprising a sensory device coupled to the virtual reality headset, the sensory device is configured to output the sensory feedback.

9. The system of claim 8, wherein the sensory attributes are one or more of: sound, moisture, heat, wind, smell, and force.

10. The system of claim 1, wherein the first action is one or more of: make a selection, scroll, zoom, change view, and move the 3D image.

11. A method for implementing a virtual retail showroom for interacting with physical objects, the method comprising:
scanning, via an optical scanner, a machine-readable element encoded with an identifier associated with a physical object;
decoding, via the optical scanner, the identifier from the machine readable element;
transmitting, via the optical scanner, the identifier, the machine-readable element being disposed in the facility, the physical object being at least one of available in the facility or available for delivery;
receiving, via the computing system, the identifier associated with the at least one physical object;
building, via the computing system, a first three dimensional (3D) virtual simulation environment including the first physical object based on the identifier; and
rendering, via a virtual reality headset including a plurality of inertial sensors and a display, the virtual reality headset being coupled to the computing system, the first 3D virtual simulation environment including the first physical object on the display;
detecting, via the virtual reality headset, a first user gesture using at least one of the plurality of inertial sensors, the first user gesture corresponding to an interaction between the user and the first 3D virtual simulation environment;
executing, via the virtual reality headset, a first action in the 3D virtual simulation environment based on the first user gesture to provide a demonstrable property or function of the first physical object; and
generating, via the virtual reality headset, sensory feedback based on a first set of sensory attributes associated with the first physical object in response to executing the first action in the 3D virtual simulation environment.

12. The method of claim 11, further comprising:
building, via the computing system, the 3D virtual simulation environment to include additional physical objects associated with additional machine-readable elements in the facility, and the first user gesture results in an interaction between the physical object and the additional physical object in the first 3D virtual simulation environment.

13. The method of claim 12, further comprising:
extracting, via the virtual reality headset, and isolate one or more 3D images of the physical object and additional physical objects from the 3D virtual simulation environment;
adjusting, via the virtual reality headset, the size of the one or more 3D images;
rendering, via the virtual reality headset, the one or more 3D images of the physical object on a first side of the display to have a first size; and
rendering, via the virtual reality headset, the one or more 3D images of the additional physical objects on a second side of the display to have a second size that is smaller than the first size to accommodate the one or more 3D images on the display.

14. The method of claim 13, wherein the user gesture corresponds to selection of at least one of the one or more 3D images of the additional physical objects.

15. The method of claim 14, further comprising, enlarging, via the virtual reality headset, the at least one or more 3D images rendered on the display, in response to selection of at least one of the one or more 3D images associated with the additional physical objects.

16. The method of claim 11, further comprising adding, via the computing system, additional physical objects associated with the first physical objects to the first 3D simulation environment.

17. The method of claim 16, further comprising
rendering, via the virtual reality headset, the first 3D virtual simulation environment including the first physical object and additional physical objects associated with the first physical object on the display;
detecting, via the virtual reality headset, a second user gesture using at least one of the plurality of inertial sensors, the second user gesture corresponding to an interaction between the user and the first 3D virtual simulation environment;
executing, via the virtual reality headset, a second action in the 3D virtual simulation environment based on the second user gesture to provide a demonstrable property or function of the at least one of the additional physical objects; and
generating, via the virtual reality headset, sensory feedback based on a second set of sensory attributes associated with the at least one of the additional physical objects in response to executing the second action in the 3D virtual simulation environment.

18. The method of claim 11, further comprising outputting, via a sensory device coupled to the virtual reality headset, the sensory feedback.

19. The method of claim 18, wherein the sensory attributes are one or more of: sound, moisture, heat, wind, smell, and force.

20. The method of claim 11, wherein the first action is one or more of: make a selection, scroll, zoom, change view, and move the 3D image.
